(19) United States
(12) Patent Application Publication
(10) Pub. No.: US 2007/0057991 A1
(43) Pub. Date: Mar. 15, 2007

(54) Ink jet image forming apparatus

(75) Inventor: Sung-wook Kang, Seoul-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/491,937

(22) Filed: Jul. 25, 2006

(30) Foreign Application Priority Data
Sep. 9, 2005 (KR) 2005-84243

(51) Int. Cl. B41J 2/165

(52) U.S. Cl. 347/33

(57) ABSTRACT

An ink jet image forming apparatus includes a print head which has a same width as a sheet of paper and includes a nozzle portion having a plurality of nozzles, a wiping unit which removes foreign materials from the nozzle portion, and a collection portion which stores the foreign materials removed by the wiping unit using a suction force caused by a negative pressure.

### CROSS-REFERENCE TO RELATED APPLICATIONS

This application claims the benefit of Korean Patent Application No. 10-2005-0084243, filed on Sep. 9, 2005, in the Korean Intellectual Property Office, the disclosure of which is incorporated herein in its entirety by reference.

### BACKGROUND OF THE INVENTION

1. Field of the Invention

The present general inventive concept relates to an ink jet image forming apparatus, and more particularly, to an ink jet image forming apparatus having a wiping unit to wipe remaining ink from a nozzle portion.

2. Description of the Related Art

Generally, ink jet image forming apparatuses form an image by dispersing ink from a shuttle type print head which is separated from the upper surface of a sheet of paper by a predetermined distance, and reciprocates perpendicular to a feeding direction of the paper (widthwise across the paper). Such a print head includes a nozzle portion having a plurality of nozzles for ejecting ink.

Recently, instead of the print head which reciprocates widthwise across the paper, a line printing (or array) type print head, which includes a nozzle portion having the same width as the paper, is being used for high speed printing. In such an ink jet image forming apparatus, only the paper is fed, and the print head is fixed. As a result, the ink jet image forming apparatus has a simple driving unit and provides high speed printing.

During a process of dispersing the ink onto the paper, foreign materials, such as remaining ink, dried ink, and fine dust from the air, may accumulate on the nozzle portion, which leads to deterioration of print quality. In order to maintain good print quality, a unit for removing the foreign materials from the nozzle portion is required.

The length of the nozzle portion of the line printing type print head is approximately 210 mm, to correspond to A4 sized paper, if left and right margins are not taken into consideration. Therefore, a unit for effectively removing the foreign materials from such a long nozzle portion is required.

In addition, the nozzle portion of the line printing type print head has four lines of nozzles to form a color image. Therefore, more ink must be removed than in a monochrome type printer. Therefore, the ink has to be completely removed so as not to contaminate peripheral units.

### SUMMARY OF THE INVENTION

The present general inventive concept provides an ink jet image forming apparatus having a wiping unit to remove ink and foreign materials from a nozzle portion, thereby maintaining good print quality.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an ink jet image forming apparatus including a print head which has the same width as a sheet of paper and includes a nozzle portion having a plurality of nozzles[;], a wiping unit which removes foreign materials from the nozzle portion[;], and a collection unit which stores and sucks the foreign materials removed by the wiping unit using a suction force caused by a negative pressure.

The foregoing and/or other aspects and advantages of the present general inventive concept are also achieved by providing a cleaning apparatus used to clean nozzles of a print head of an ink jet image forming apparatus, including a wiping unit to move along a length of the print head to remove foreign materials and remaining ink from the nozzles, and a collection unit connected to the wiping unit to applying a section force to the wiping unit to collect the foreign materials and remaining ink from the wiping unit.

The collection unit may include a flexible tubular member to connect to the wiping unit in which the foreign materials and remaining ink are collected therethrough.

The wiping unit may include a wiper that projects from the wiping unit at one end thereof to wipe the nozzles, an entrance portion adjacent to the wiper to collect the foreign materials and remaining ink wiped by the wiper; and at least one suction passage in which the foreign materials and remaining ink can enter.

The collection unit may include a pump to provide a suction force to suck the foreign materials and remaining ink from the at least one suction passage, a suction unit connected at one end to the at least one suction passage through a tube and connected at another end to the pump by a second tube to control the sucking force of the pump, and a storage to store the ink and foreign materials sucked by the pump.

The suction unit may include a body including a connection portion connecting the suction unit to the tube, and a rotation body rotatably disposed in the body and includes a plurality of wings, the rotation body being rotated in the body by the suction force of the pump such that when the rotation body rotates, the wings regularly and continuously open and close the connection portion.

The storage may be disposed along the second tube between the suction unit and the pump.

The wiper can have a width as wide as the print head, and the at least one suction passage may include a plurality of suction passages adjacent to each other along the width of the wiper.

The tube can be flexible such that the wiping unit moves along the length of the print head while the suction unit remains stationary and connected to the wiping unit via the tube.

The foregoing and/or other aspects and advantages of the present general inventive concept are also achieved by providing a cleaning apparatus to clean nozzles of an inkjet print head, including a wiping unit including a wiper and body to wipe foreign materials and ink from the nozzles of the print head and to collect the foreign materials and ink, respectively, a pump connected to the body of wiping unit through a tube to pump the foreign materials and ink through the body toward the pump; and a suction unit connected between the pump and the wiping unit along the tube and including a rotating body to continuously increase and decrease a pumping pressure of the pump along the tube such that the foreign materials and ink are sucked through the body of the wiping unit and through to tube.

The cleaning apparatus may further include a storage disposed along the tube between the pump and the suction unit to collect the foreign materials and ink from the tube.

The wiper may extend upward from the body such that the wiped foreign materials and ink move along the wiper to the body.

The rotating body of the suction unit may include wings therein that open and close the tube to increase and decrease the pumping pressure.

The foregoing and/or other aspects and advantages of the present general inventive concept are also achieved by providing a cleaning apparatus used to clean print head nozzles of an ink jet image forming apparatus, including a wiping unit to move along a length of the print head to remove foreign materials and remaining ink from the nozzles, the wiping unit including a wiper member to wipe the nozzles and a body portion to collect therein the removed foreign materials and remaining ink, and a pumping unit connected to the body portion of the wiping unit via a tube to apply a variable suction force to the body portion to suck the collected foreign materials and remaining ink therefrom.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view of an ink jet image forming apparatus according to an embodiment of the present general inventive concept;

FIG. 2 is a rear view of a nozzle portion of a print head of FIG. 1;

FIG. 3 is a plan view of a wiping unit of FIG. 1;

FIG. 4 is a side view of a wiping unit of FIG. 1, according to another embodiment of the present general inventive concept;

FIG. 5 is a view illustrating the operation of removing foreign materials from a nozzle using a wiping unit;

FIG. 6 is a view illustrating the operation of sucking foreign materials from a wiping unit using a suction unit; and

FIG. 7 is a graph illustrating the pressure change of a suction unit when sucking foreign materials.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

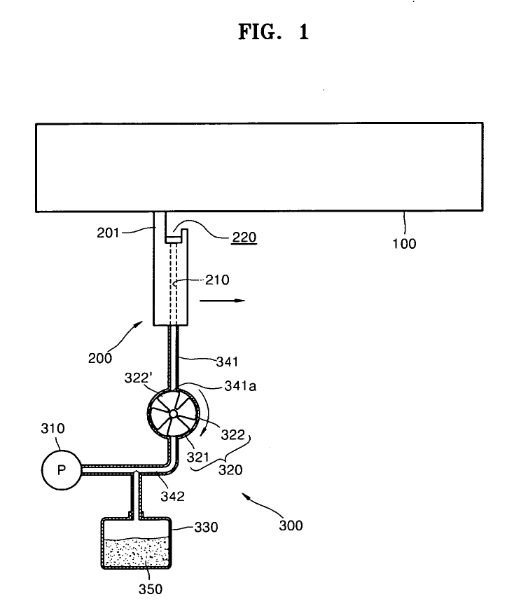

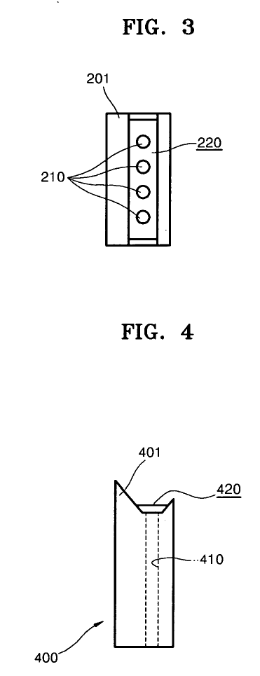

Referring to FIGS. 1 to 3, an ink jet image forming apparatus according to an embodiment of the present general inventive concept includes a print head 100 which provides a nozzle portion 110 having a same width as a paper (or other recording medium), a wiping unit 200 which removes foreign materials from the nozzle portion 110, and a collection portion 300 which collects the foreign materials removed by the wiping unit 200.

The print head 100 is a line array head having the same width as a recording medium and provides the nozzle portion 110 which includes four lines 110Y, 110M, 110C, and 110K having a plurality of nozzles to respectively eject yellow Y, magenta M, cyan C, and black K inks from their lower surface thereof. The inks ejected from the nozzle portion 110 are superimposed to form a color image.

The wiping unit 200 moves lengthwise along the print head 100 and contacts the nozzle portion 110 to remove the ink and foreign materials remaining thereon, and includes a wiper 201 which contacts the nozzle portion 110 to wipe the nozzle portion 110, an entrance 220 which has a space at an upper portion of the wiping unit 200 so that the ink and foreign materials removed by the wiper 201 can be temporarily stored, and a plurality of suction passages 210 which are connected with the entrance 220 and allow the ink and foreign materials stored in the entrance 220 to flow to the collection portion 300.

In addition, as illustrated in FIG. 4, a wiping unit 400 may have a different form from that of FIG. 1. However, only a wiper 401 and an entrance 420 have different forms, and suction passages 410 connected with the entrance 420 are similar.

The wiping unit 200 is positioned such that it can be slid lengthwise along the lower surface of the print head 100 by an additional feeding unit (not shown). Since the feeding unit can be implemented using a conventional device, a detailed description thereof will be omitted.

The collection portion 300 includes a suction unit 320 which is connected to the entrance 220 by a tube 341, a pump 310 which is connected with the suction unit 320 by a tube 342 and provides a suction force so that the suction unit 320 can suck the ink and foreign materials from the entrance 220, and a storage 330 which stores the ink and foreign materials sucked by the suction unit 320.

The suction unit 320 includes a body 321 which is connected with the suction passages 210 by the tube 341 and is connected to the pump 310 and the storage 330 by the tube 342, and a rotation body 322 which is rotatably disposed in the body 321 and is composed of a plurality of wings 322′. The rotation body 322 is rotated in the body 321 by the suction force of the pump 310. As the rotation body 322 rotates, the wings 322′ regularly and continuously open and close a connection portion 341a connecting the tube 341 and the wings 322′.

The tube 341 can have a sufficient length and can be made of a flexible material, so that although the wiping unit 200 moves lengthwise along the print head 100, the suction unit 320 does not move and the tube 341 can maintain the connection with the wiping unit 200.

A wiping operation of the ink jet image forming apparatus according to an embodiment of the present general inventive concept having the aforementioned configuration will be described with reference to the drawings.

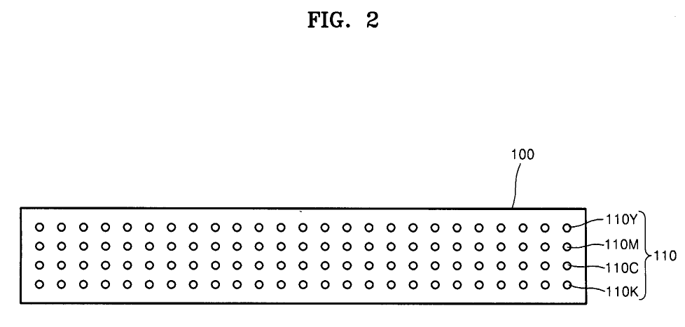

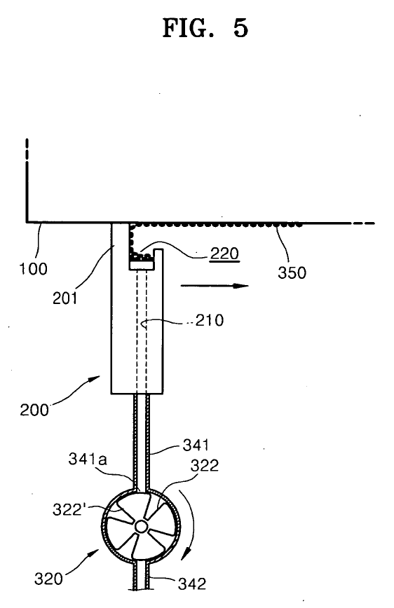

Referring to FIGS. 2 and 5, the wiping unit 200 moves lengthwise along the print head 100, and the wiper 201 wipes the nozzle portion 110 to remove ink and foreign materials.

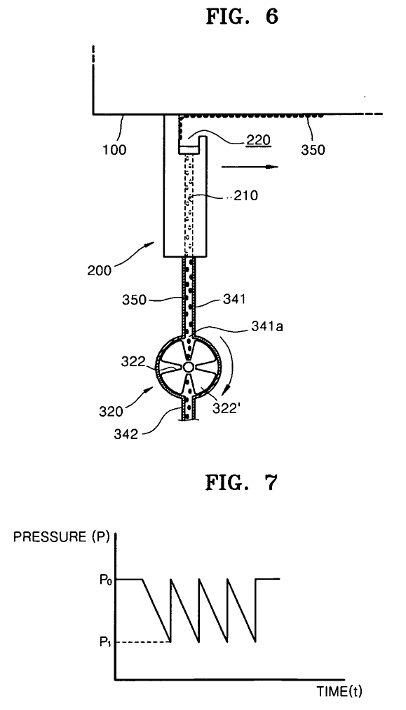

The removed ink and foreign materials 350 flow down the wiper 201 and are temporarily stored in the entrance 220. At this time, the wings 322′ of the rotation body 322 block the connection portion 341a. Thus, the ink and foreign materials 350 stored in the entrance 220 cannot flow into the suction unit 320 through the suction passages 210. As the suction force of the pump 310 increases, the inner pressure of the rotation body 322 gradually increases to reach a state P0 of FIG. 7.

Of course, a portion of the ink and foreign materials 350 may flow down along the suction passages 210, but most are stored in the entrance 220 due to viscosity.

Referring to FIG. 6, as the wings 322′ of the rotation body 322 pass the connection portion 341a, the tube 341 is connected with the rotation body 322, and the pressure of the rotation body 322 rapidly decreases to reach a state P1 of FIG. 7. Due to the negative pressure (ΔP=P1−P0), the ink and foreign materials 350 stored in the entrance 220 flow into the suction unit 320 through the suction passages 210 and the tube 341.

The ink and foreign materials 350 flow from the suction unit 320 into the storage 330 along the tube 342 due to the suction force of the pump 310, and are then stored therein.

As the rotation body 322 rotates, the wings 322′ regularly and continuously open and close the connection portion 341a. By using the negative pressure caused by the pressure difference between the pressure P0 of the suction unit 320 when the wings 322′ block the connection portion 341a and the pressure P1 of the suction unit 320 when the wings 322′ open the connection portion 341a, the ink and foreign materials 350 stored in the entrance 220 are sucked into the suction unit 320 and stored in the storage 330.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink jet image forming apparatus comprising:
a print head having the same width as a sheet of paper and a nozzle portion having a plurality of nozzles;
a wiping unit which removes foreign materials from the nozzle portion; and
a collection portion which stores and sucks the foreign materials removed by the wiping unit.

2. The apparatus according to claim 1, wherein the wiping unit comprises a plurality of suction passages which guide the foreign materials removed from the nozzle so that the foreign materials can flow into the collection portion.

3. The apparatus according to claim 2, wherein the collection portion comprises:
a suction unit which is connected with the plurality of suction passages and sucks the foreign materials using a pressure difference by regularly opening and closing the plurality of suction passages;
a pump which provides the suction force so that the suction unit can suck the foreign materials; and
a storage which stores the foreign materials sucked by the suction unit.

4. The apparatus according to claim 3, wherein the suction unit comprises a body having an empty interior portion, and a rotation body which is provided in the body and has a plurality of wings, and generates the negative pressure when the rotating body rotates and the wings regularly open and close the suction passages.

5. The apparatus according to claim 4, wherein the rotating body is rotated by the suction force of the pump.

6. The apparatus according to claim 2, wherein the wiping unit comprises an entrance at the upper portion of the wiping unit so that the foreign materials removed from the nozzle can flow into the suction passages.

7. The apparatus according to claim 1, wherein the wiping unit moves lengthwise along the print head and wipes the nozzle portion.

8. A cleaning apparatus used to clean nozzles of a print head of an ink jet image forming apparatus, comprising:
a wiping unit to move along a length of the print head to remove foreign materials and remaining ink from the nozzles; and
a collection unit connected to the wiping unit to applying a suction force to the wiping unit to collect the foreign materials and remaining ink from the wiping unit.

9. The cleaning apparatus according to claim 8, wherein the collection unit comprises a flexible tubular member to connect to the wiping unit in which the foreign materials and remaining ink are collected therethrough.

10. The cleaning apparatus according to claim 8, wherein the wiping unit comprises:
a wiper that projects from the wiping unit at one end thereof to wipe the nozzles;
an entrance portion adjacent to the wiper to collect the foreign materials and remaining ink wiped by the wiper; and
at least one suction passage in which the foreign materials and remaining ink can enter.

11. The cleaning apparatus according to claim 10, wherein the collection unit comprises:
a pump to provide a suction force to suck the foreign materials and remaining ink from the at least one suction passage;
a suction unit connected at one end to the at least one suction passage through a tube and connected at another end to the pump by a second tube to control the sucking force of the pump;
and
a storage to store the ink and foreign materials sucked by the pump.

12. The cleaning apparatus according to claim 11, wherein the suction unit comprises:
a body including a connection portion connecting the suction unit to the tube; and
a rotation body rotatably disposed in the body and includes a plurality of wings, the rotation body being rotated in the body by the suction force of the pump such that when the rotation body rotates, the wings regularly and continuously open and close the connection portion.

13. The cleaning apparatus according to claim 11, wherein the storage is disposed along the second tube between the suction unit and the pump.

14. The cleaning apparatus according to claim 11, wherein the wiper has a width as wide as the print head, and the at least one suction passage includes a plurality of suction passages adjacent to each other along the width of the wiper.

15. The cleaning apparatus according to claim 14, wherein the tube is flexible such that the wiping unit moves along the length of the print head while the suction unit remains stationary and connected to the wiping unit via the tube.

16. A cleaning apparatus to clean nozzles of an inkjet print head, comprising:
a wiping unit including a wiper and body to wipe foreign materials and ink from the nozzles of the print head and to collect the foreign materials and ink, respectively;
a pump connected to the body of wiping unit through a tube to pump the foreign materials and ink through the body toward the pump; and
a suction unit connected between the pump and the wiping unit along the tube and including a rotating body to continuously increase and decrease a pumping pressure of the pump along the tube such that the foreign materials and ink are sucked through the body of the wiping unit and through the tube.

17. The cleaning apparatus according to claim 16, further comprising:
a storage disposed along the tube between the pump and the suction unit to collect the foreign materials and ink from the tube.

18. The cleaning apparatus according to claim 16, wherein the wiper extends upward from the body such that the wiped foreign materials and ink move along the wiper to the body.

19. The cleaning apparatus according to claim 16, wherein the rotating body of the suction unit comprises wings therein that open and close the tube to increase and decrease the pumping pressure.

20. A cleaning apparatus used to clean print head nozzles of an ink jet image forming apparatus, comprising:
a wiping unit to move along a length of the print head to remove foreign materials and remaining ink from the nozzles, the wiping unit including a wiper member to wipe the nozzles and a body portion to collect therein the removed foreign materials and remaining ink; and
a pumping unit connected to the body portion of the wiping unit via a tube to apply a variable suction force to the body portion to suck the collected foreign materials and remaining ink therefrom.
